(19) United States
(12) Patent Application Publication
(10) Pub. No.: US 2005/0111210 A1
(43) Pub. Date: May 26, 2005

(54) Lenticular display backlit by an electro-luminescent light source

(76) Inventor: Bryan K. Ono, Pacific Palisades, CA (US)

Correspondence Address: Charles D. Gunter, Jr.;Whitaker, Chalk, Swindle & Sawyer, LLP, 3500 City Center Tower II, 301 Commerce Street, Fort Worth, TX, 76102-4186, US

(21) Appl. No.: 10/920,924

(22) Filed: Aug. 18, 2004

Related U.S. Application Data
(60) Provisional application No. 60/497,001, filed on Aug. 20, 2003.

(51) Int. Cl. F21V 9/16

(52) U.S. Cl. 362/84

(57) ABSTRACT

The present invention provides an article of clothing with a backlit translucent lenticular lens display that emits light that allows animation and special effects by design which can distinguish the user by the performance of an article of clothing. A garment has attached to a surface a display module having a substantially flat PVC envelope enclosing an electro-luminescent lamp layer and a translucent lenticular lens layer. The electro-luminescent lamp layer is energized by an electrical signal from an control electronic circuit. The electro-luminescent layer may be divided into segments where each segment functions as an independent electro-luminescent layer receiving a potential having a pattern of illumination that is determined by the control electronic circuit. The invention can be used in safety apparel where the resulting pattern is a bright surface having the shape of a caution warning.

### CROSS-RELATED APPLICATIONS

The present application claims priority from Provisional Application Ser. No. 60/497,001, filed Aug. 20, 2003, entitled “Lentricular Display Backlit by an Electro-Luminescent Light Source”, by the same inventors.

### BACKGROUND OF THE INVENTION

1. Field of the Invention

This invention is related to garments having dynamic optical displays on their surface. In particular it is related to such displays employing an electro-luminescent light source.

2. Description of the Prior Art

Garments are known that have designs on acetate layers illuminated by an electro-luminescent lamp. Garments and accessories with lenticular layers are also known. The combination of a lenticular luminescent screen having a base plate of a transparent material containing a substance capable of emitting luminescent light in response to stimulating light is known in U.S. Pat. No. 5,021,931. However the combination in a garment having a lenticular translucent design backlit by an electro-luminescent layer is not previously known and thus the prior art does not disclose a convenient manner for creating effective bright displays on a surface of the garment.

### SUMMARY OF THE INVENTION

In view of the aforesaid drawback of the conventional systems, it is an object of the present invention to proved a more effective luminescent system for use on a garment allowing a greater degree of brightness and greater control over the details of the display.

In one embodiment the invention comprises a garment having attached to a surface thereof a display module that comprises a substantially flat PVC envelope having a transparent front surface. Inside the envelope is an electro-luminescent lamp layer and a translucent lenticular lens layer that has the effect of diffusing the light from the electro-luminescent lamp layer.

To energize the electro-luminescent lamp layer an electrical signal is brought from a battery power source and an electrical inverter under the control of an control electronic circuit that determines when the layer emits light. A more complex arrangement has the electro-luminescent layer divided into segments where each segment functions as an independent electro-luminescent layer receiving a potential having a pattern of illumination that is determined by the control electronic circuit.

The invention can be used in safety apparel where the resulting pattern is a bright surface having the shape of a caution warning. The present invention provides an article of clothing with a backlit translucent lenticular lens display that emits light that allows animation and special effects by design which can distinguish the user by the performance of an article of clothing.

### BRIEF DESCRIPTION OF THE DRAWINGS

FIG. 1 depicts a cross section of a display module of the present invention.

FIG. 2 depicts a electro-luminescent layer that is divided into independent segments.

FIG. 3 depicts a garment shown in an exploded view and in perspective the components of a display sewn thereon.

### DETAILED DESCRIPTION OF THE INVENTION

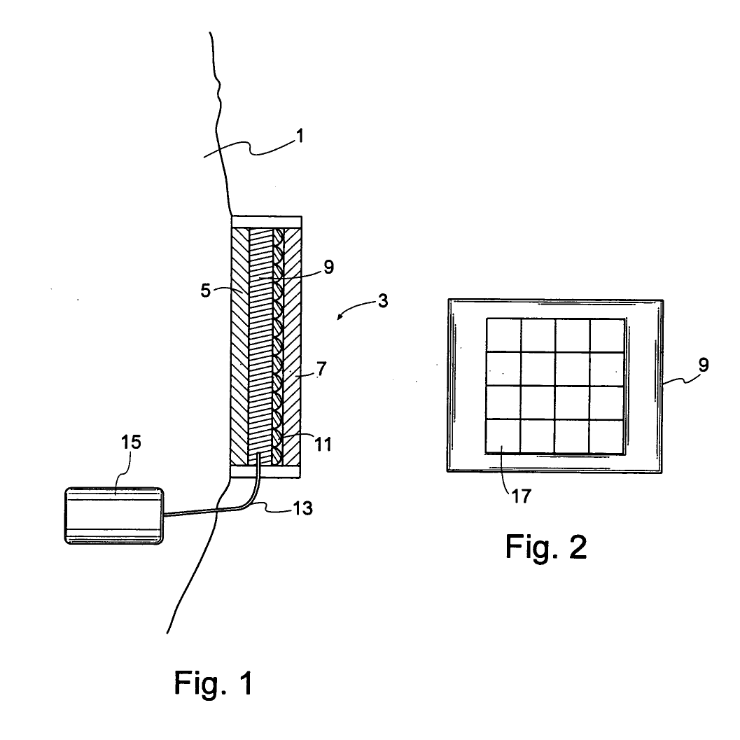

As shown in FIG. 1, a garment 1 has attached to a surface thereof a display module 3. The module may be attached either permanently by being sewn or stapled to the garment or by use of a removable attachment mechanism such as velcro, snaps, zippers or the like. The module 3 comprises an envelope having a transparent surface such as a substantially flat PVC envelope having a back surface 5 for attachment to the garment 1 and a transparent front surface 7. The transparency of the front surface 7 need not be total, but need only be sufficiently transparent to allow light from inside the envelope to escape through the front surface. Inside the envelope is an electro-luminescent lamp layer 9 in contact with the back surface of the envelope. In contact with this layer is a lenticular lens layer 11, which is in contact with the front surface 7 of the PVC envelope. The lenticular lens layer 11 is preferably translucent and has the effect of diffusing the light from the electro-luminescent lamp layer.

To energize the electro-luminescent lamp layer 11 a signal is brought by a wiring harness 13 from a pack 15 comprising a battery power source and an electrical inverter. The function of the inverter is to convert the direct current from the battery to an alternating current known to persons of skill in this art as sufficient to cause the electro-luminescent layer to emit light. The pack further comprises a control electronic circuit that determines when the layer 9 emits light. A simple control might only cause the layer 9 to flash periodically. A more complex arrangement could involve a electro-luminescent layer that is divided into segments. This is shown in FIG. 2, which depicts such a layer divided into segments 17. In effect each segment functions as an independent electro-luminescent layer receiving a potential from the inverter and having a pattern of illumination that is determined by the control electronic circuit. The segments 17, can be as small as desired in order to provide a display of any desired detail.

The lenticular lens layer 11, which is preferably translucent, provides a uniform intensity of light from the electro-luminescent layer and efficiently brings the light from the layer to pass through the front surface of the PVC envelope.

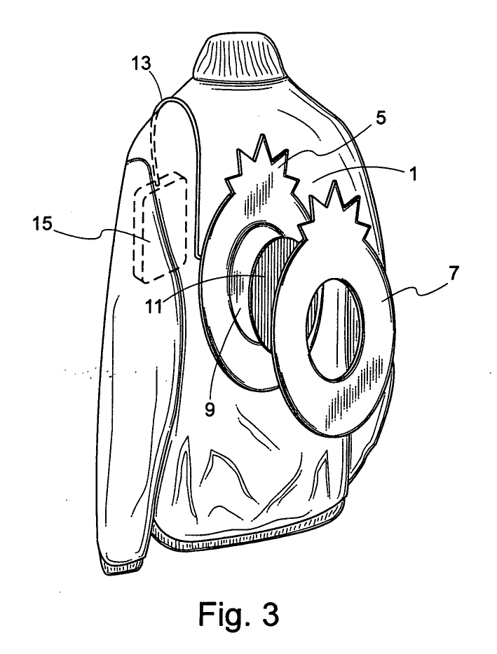

FIG. 3 depicts the various elements in an exploded view shown in perspective in conjunction with a garment.

In use, the garment has the PVC envelope attached to a surface thereof. When turned on, electrical 5 signals from the pack 15 under control of the control electronic circuit, which may be nothing more than an array of switching circuits in conjunction with timing circuits arranged to produce a desired visible pattern, cause the elements of the electro-luminescent layer to emit light. The light from the electro-luminescent layer is focused by elements of the lenticular layer and exit from the front surface of the PVC layer. This could be done for example in conjunction with safety apparel where the resulting pattern is a bright surface having the shape of a caution warning. This would enable the wearer to be safely identified even in darkness, rain, smoke and fog and in low light conditions where visibility is limited.

The present invention provides additional advantages. In particular it provides an article of clothing with a backlit translucent lenticular lens display that emits light. Unlike constant lighting displays the present invention allows animation and special effects by design which can distinguish the user by the performance of an article of clothing.

Although the invention has been discussed in terms of a particular embodiments it will be understood by persons of skill in this art that it encompasses any use of its technology as described in the following claims.

1. A garment having a display module, comprising:
a PVC envelope attached to an outside surface thereof, said PVC envelope comprising a back surface and a transparent front surface, said envelope containing:
an electro-luminescent lamp layer that emits light in response to a driving electrical potential, and
a translucent lenticular lens layer receiving light from said electro-luminescent lamp
layer and transmitting said light through said transparent front surface;
an electrical inverter receiving power from a battery and providing the driving potential to the electro-luminescent lamp layer in response to a control electronic circuit.

2. The garment of claim 1, wherein the electro-luminescent lamp layer is comprised of segments that separately emit light in response to driving electrical potential controlled by a control electronic circuit.

3. The garment of claim 1, wherein the electro-luminescent lamp layer flashes in response to signals from said control electronic circuit.

4. The garment of claim 2, wherein segments of said electro-luminescent lamp layer separately flash in response to signals from said control electronic circuit.

5. The garment of claim 2, wherein segments of said electro-luminescent lamp layer are separately illuminated in response to signals from said control electronic circuit to create an animated image visible through the transparent front surface of said PVC envelope.

6. The garment of claim 1, wherein said PVC envelope is sewn on the garment.
